(19) United States
(12) Patent Application Publication
(10) Pub. No.: US 2008/0132216 A1
(43) Pub. Date: Jun. 5, 2008

(54) Forwarding Messages Via Intermediate Telephones

(76) Inventors: Curtis Duane Kronlund, Cottage Grove, MN (US); Scott Alan Moore, Rochester, MN (US); Gregory Allan Olson, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(21) Appl. No.: 11/557,807

(22) Filed: Nov. 8, 2006

(51) Int. Cl. H04M 3/42; H04Q 7/20

(52) U.S. Cl. 455/417; 455/432.1; 455/466

(57) ABSTRACT

In various embodiments, a source telephone receives message data and an identifier of a destination telephone, either from a user interface or from an origin telephone. In response to detecting that the source telephone is not located within a cell, the source telephone selects an intermediate telephone that is connected to the source telephone via a local wireless network. The source telephone then sends a forward request to the intermediate telephone. The forward request includes the message data and the identifier of the destination telephone. In various embodiments, the intermediate telephone is selected if it is located within a cell, if it is moving toward a cell, or if its estimated arrival time at one of the cells is earlier than the estimated arrival time of the source telephone. The forward request instructs the intermediate telephone to forward the message data upon reaching the cell or to another intermediate telephone.

### FIELD

This invention generally relates to wireless telecommunications and more specifically relates to the forwarding of messages using intermediate telephones.

### BACKGROUND

Wireless telephones have become a popular way to communicate, and may be used both for calls and for messages. Wireless telephones work by communicating via radio waves using a system of base stations (sometimes known as “cell sites”) that send and receive calls and relay them to other networks, such as the Public Switched Telephone Network (PSTN). Because wireless telephones communicate using radio waves, their reliability is influenced by many factors, such as the proximity of the telephone to the base station with which it is communicating, physical obstacles, and interference or noise. Noise refers to unwanted electronic signals introduced by circuit components or natural disturbances that tend to distort communications. The locations where calls cannot be made due to these limitations are sometimes referred to as “dead zones,” “coverage holes,” “dead spots,” or “obstructed areas.” If a telephone cannot complete a call using the subscriber's wireless service provider, the telephone might be able to still make the call using roaming.

Roaming occurs when a subscriber of one wireless service provider uses the facilities of a second provider. While the subscriber usually has no pre-existing agreement with the second provider to handle calls, the subscriber's provider may have a “roaming agreement” with the second provider. Under that agreement, the second provider agrees to handle calls placed by subscribers of the first provider and vice versa. Although roaming is a convenience, it often is more expensive than using the subscriber's regular provider. Further, if the telephone is outside the range of any service provider, then roaming is not available, and communication is not possible until the telephone moves within the range of a base station.

Thus, a better way is needed to communicate when wireless telephone subscribers cannot connect to their service provider.

### SUMMARY

A method, apparatus, system, and signal-bearing medium are provided. In various embodiments, a source telephone receives message data and an identifier of a destination telephone, either from a user interface or from an origin telephone. In response to detecting that the source telephone is not located within a cell, the source telephone selects an intermediate telephone that is connected to the source telephone via a local wireless network and that meets a security criteria. The source telephone then sends a forward request to the intermediate telephone. The forward request includes the message data and the identifier of the destination telephone. In various embodiments, the intermediate telephone is selected if it is located within a cell, if it is moving toward a cell, or if its estimated arrival time at one of the cells is earlier than the estimated arrival time of the source telephone. The forward request instructs the intermediate telephone to forward the message data upon reaching the cell or to another intermediate telephone. In this way, telephones may communicate even when not located within cells.

### BRIEF DESCRIPTION OF THE DRAWINGS

FIG. 1 depicts a block diagram of an example system for implementing an embodiment of the invention.

FIG. 2 depicts a block diagram of selected components of the example system, according to an embodiment of the invention.

FIG. 3 depicts a block diagram of a telephone, according to an embodiment of the invention.

FIG. 4 depicts a block diagram of a base station, according to an embodiment of the invention.

FIG. 5 depicts a block diagram of base station data, according to an embodiment of the invention.

FIG. 6 depicts a block diagram of telephone data, according to an embodiment of the invention.

FIG. 7 depicts a block diagram of a message cache, according to an embodiment of the invention.

FIG. 8 depicts a block diagram of a negotiation request, according to an embodiment of the invention.

FIG. 9 depicts a block diagram of a negotiation response, according to an embodiment of the invention.

FIG. 10 depicts a block diagram of a forward criteria, according to an embodiment of the invention.

FIG. 11 depicts a flowchart of example processing for receiving signals from GPS (Global Positioning System) satellites, according to an embodiment of the invention.

FIG. 12 depicts a flowchart of example processing for message data, according to an embodiment of the invention.

FIG. 13 depicts a flowchart of example processing for sending messages, according to an embodiment of the invention.

FIG. 14 depicts a flowchart of example processing for selecting an intermediate telephone, according to an embodiment of the invention.

FIG. 15 depicts a flowchart of example processing for a negotiation request, according to an embodiment of the invention.

FIG. 16 depicts a flowchart of example processing for forward requests, according to an embodiment of the invention.

FIG. 17 depicts a flowchart of example processing for selecting between candidate telephones, according to an embodiment of the invention.

### DETAILED DESCRIPTION

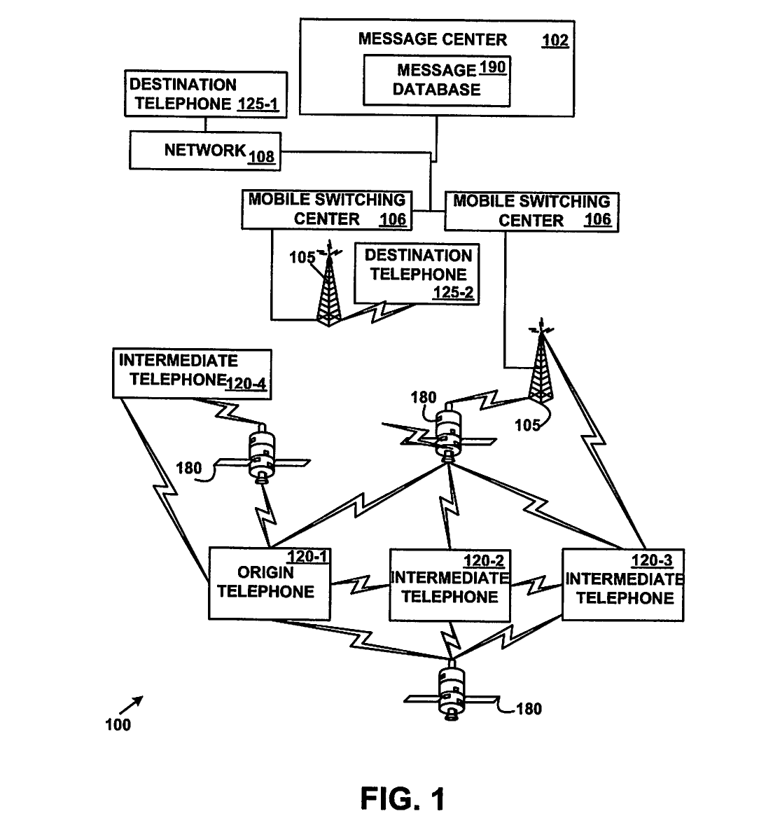

FIG. 1 depicts a block diagram of an example system 100 for implementing an embodiment of the invention. The system 100 includes a message center 102, base stations 105, mobile switching centers 106, a network 108, an origin telephone 120-1, intermediate telephones 120-2, 120-3, and 120-4, destination telephones 125-1 and 125-2, and GPS (Global Positioning System) satellites 180. The destination telephone 125-1 is connected to the network 108. The base stations 105 are connected to their respective mobile switching centers 106. The message center 102, the mobile switching centers 106, and the network 108 are connected either by wireless signals or hard wires.

The GPS satellites 180 orbit the earth and transmit signal information, which the telephones 120-1, 120-2, 120-3, 120-4 and the base stations 105 receive and use to calculate their respective locations. The telephones 120-1, 120-2, 120-3, and 120-4 further use the signal information to calculate other information, such as their speed of movement, direction, and distance to various locations. The destination telephone 125-2 is illustrated in FIG. 1 as not receiving signals from the GPS satellites 180, but in another embodiment, the destination telephone 125-2 does receive signals from the GPS satellites 180 and does calculate its speed of movement, direction, and distance to various locations.

The telephones 120-1, 120-2, 120-3, 120-4, and 125-2 send and receive wireless signals to and from the base stations 105 if the telephones are within the signal transmission area of the cell of a base station 105, in order to place telephone calls and send and receive messages. The telephone 125-1 connects to the network 108, in order to place telephone calls and send and receive messages. The various telephones 120-1, 120-2, 120-3, 120-4, 125-1, and 125-2 may be of the same or of different types, may be connected to the same or different types of networks and may use the same or different service providers.

The mobile switching centers 106 perform call routing, connecting calls together and sending messages by switching packets from one network path to another. The mobile switching centers 106 may also register, authenticate, and update the locations of the telephones.

The message center 102 includes a message database 190, which stores messages intended for the telephones if the telephone is not answered, not connected, or not within the cell transmission area of a base station 105. The message center 102 may be implemented as part of a computer system or other electronic device. Users at the various telephones may send, store, retrieve, forward, or reply to messages stored in the message database 190.

The origin telephone 120-1 initiates a message that its user desires to send to the destination telephone 125-1 or 125-2. But, the origin telephone 120-1 is not within any of the cells of the base stations 105, so the origin telephone 120-1 sends a forward request that includes the message to one or more intermediate telephones 120-2 and 120-4, which in turn send or forward the message to the base station 105 (if within its cell) or to another intermediate telephone, such as the intermediate telephone 120-3. Once an intermediate telephone reaches the cell of the base station 105, the intermediate telephone sends the forwarded message to the base station 105. Once the message reaches the base station 105, the base station 105 sends the message to its mobile switching center 106, which sends the message on to the destination telephone 125-1 or 125-2 (via the same or another mobile switching center, and/or the network 108), or to the message database 190, where it can be retrieved by the destination telephone at a later time. The telephones are labeled “origin,” “intermediate,” and “destination” as illustrative names only, and in various embodiments a telephone that serves as an origin for one message may be an intermediate or a destination for another message.

The network 108 may be any suitable network or combination of networks and may support any appropriate protocol suitable for communication of data and/or code. In various embodiments, the network 108 may be a PSTN (Public Switched Telephone Network, ISDN (Integrated Service Digital Network), or FDDI (Fiber Distributed Data Interface). In various embodiments, the network 108 may support wireless communications or hard-wired communications, such as a telephone line or cable.

In another embodiment, the network 108 may support the Infiniband architecture. In another embodiment, the network 108 may support the Ethernet IEEE (Institute of Electrical and Electronics Engineers) 802.3x specification. In another embodiment, the network 108 may be the Internet and may support IP (Internet Protocol). In another embodiment, the network 108 may be a local area network (LAN) or a wide area network (WAN). In another embodiment, the network 108 may be a hotspot service provider network. In another embodiment, the network 108 may be an intranet. In another embodiment, the network 108 may be a GPRS (General Packet Radio Service) network. In another embodiment, the network 108 may be a FRS (Family Radio Service) network. In another embodiment, the network 108 may be any appropriate cellular data network or cell-based radio network technology. In another embodiment, the network 108 may be an IEEE 802.11 B wireless network. In another embodiment, the network 108 may be any suitable network or combination of networks. Although one network 108 is shown, in other embodiments any number of networks (of the same or different types) may be present.

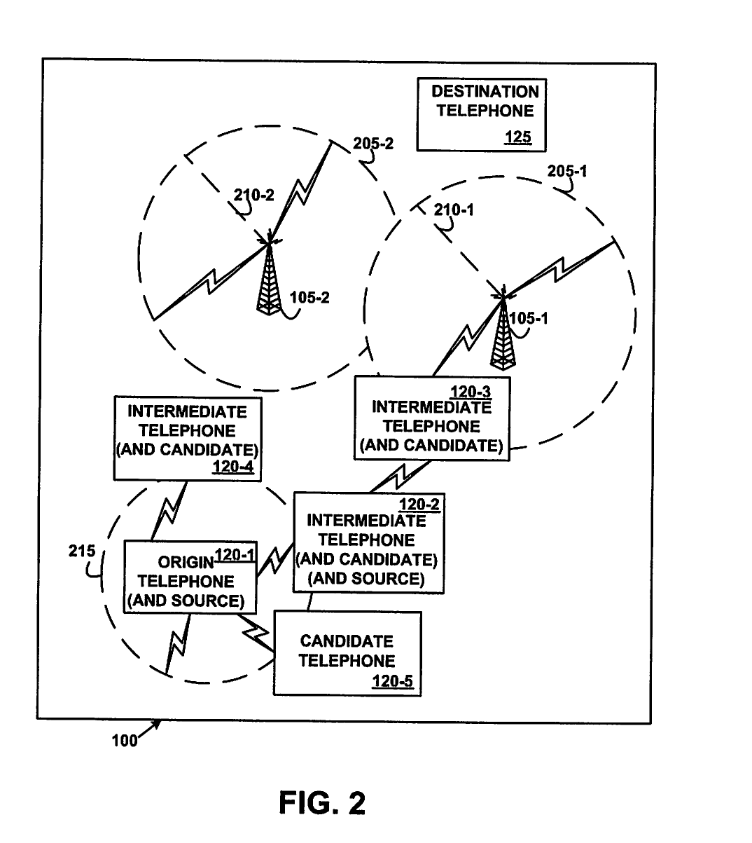

FIG. 2 depicts a block diagram of selected components of the example system 100, according to an embodiment of the invention. Selected components of the example system 100 include the base stations 105-1 and 105-2 and telephones 120-1, 120-2, 120-3, 120-4, 120-5, and 125. The base station 105 (FIG. 1) generically refers to the base stations 105-1 and 105-2. The destination telephone 125 generically refers to the destination telephones 125-1 and 125-2 (FIG. 1).

Each of the base stations 105-1 and 105-2 transmits and receives wireless radio signals in a respective cell 205-1 and 205-2. The cells 205-1 and 205-2 are the geographical areas covered by the signal of the cellular telephone transmitter included in the respective base station (also called a cell site) 105-1 or 105-2. The cell 205-1 or 205-2 provided by a base station typically has a respective radius 210-1 or 210-2 of from 0.5 to 10 miles, depending on terrain and transmission power, but in other embodiments any appropriate cell size may be used. The cells 205-1 and 205-2 are illustrated in FIG. 2 as being circular in shape, which is a theoretical shape. But, the actual size and shape of cells are often irregular and change over time based on obstructions, weather, and transmission power. Nevertheless, a circle may be used as an estimate of the shape of the cell signal area, and the estimated radius 210-1 or 210-2 of the circle may be calculated based on the power and sensitivity of the base station, or actual measurements may be taken.

The telephone 120-3 is located within the cell 205-1 of the base station 105-1, so the telephone 120-3 is capable of sending and receiving signals to and from the base station 105-1 if the telephone 120-3 is powered on and operating normally. The telephones 120-1, 120-2, 120-4, and 120-5 are not located within either of the cells 205-1 or 205-2, so the telephones 120-1, 120-2,120-4, and 120-5 are not capable of sending and receiving signals to and from the base stations 105-1, 105-2.

The telephone 120-1 is capable of communicating via a local wireless network with telephones that are located within the transmission area 215 of the telephone 120-1, such as the telephones 120-2, 120-4, and 120-5. The telephone 120-3 is not within the transmission area of the local wireless network of the telephone 120-1, so they are not able to communicate directly via a local wireless network. Although the transmission area 215 of the local wireless network is illustrated as a circle, the actual size and shape of the transmission area 215 may often be irregular and may change over time based on obstructions, weather, and power. In an embodiment, the local wireless network is implemented via a personal area network (PAN), a Bluetooth network, or a WPAN (Wireless Personal Area Network). In an embodiment, the telephones communicate via radio waves on the local wireless network directly, without an intermediate repeater.

In the example of FIG. 2, the telephone 120-1 is an origin telephone, meaning that it originates or creates message data that it desires to send to the destination telephone 125. The telephone 120-1 is also a source telephone, meaning that it has a message that it desires to forward and that it sends negotiation requests to any candidate telephones located with its local wireless network transmission area 215. The telephones 120-2, 120-4, and 120-5 are candidate telephones with respect to the source telephone 120-1, meaning that they are located within the wireless transmission area 215 of the local wireless network of the source telephone 120-1, they receive a negotiation request from the source telephone 120-1, and they send a negotiation response to the source telephone 120-1.

The source telephone 120-1 selects one or more intermediate telephones (e.g., the intermediate telephones 120-2 and 120-4) from the candidate telephones 120-2, 120-4, and 120-5, and sends the message to the intermediate telephones 120-2 and 120-4 with a request to forward the message to the destination telephone 125. Although the telephone 120-2 is an intermediate telephone with respect to the telephone 120-1, the telephone 120-2 is a source telephone with respect to the telephone 120-3 because the telephone 120-2 has a message (received from the telephone 120-1) that it desires to forward, and it sends a negotiation request to the candidate telephone 120-3, which is located with the transmission area of the telephone 120-2. The telephone 120-2 selects the telephone 120-3 as an intermediate telephone and sends the forwarded message to the telephone 120-3, which forwards the message to the base station 120-3 since the telephone 120-3 is already located within the cell 205-1. The telephone 120-4 sends the forwarded message to one of the base stations 105 after it reaches its cell. Thus, in various embodiments, intermediate telephones may send forwarded messages to other intermediate telephones or to the base station after entering a cell.

The labels “origin,” “source,” “candidate,” “intermediate,” and “destination,” are for convenience only to describe roles that telephones take on with respect to messages and with respect to other telephones. In various embodiments, a telephone that acts as one role with respect to a particular message and a particular telephone may act as another role with respect to another message and/or another telephone.

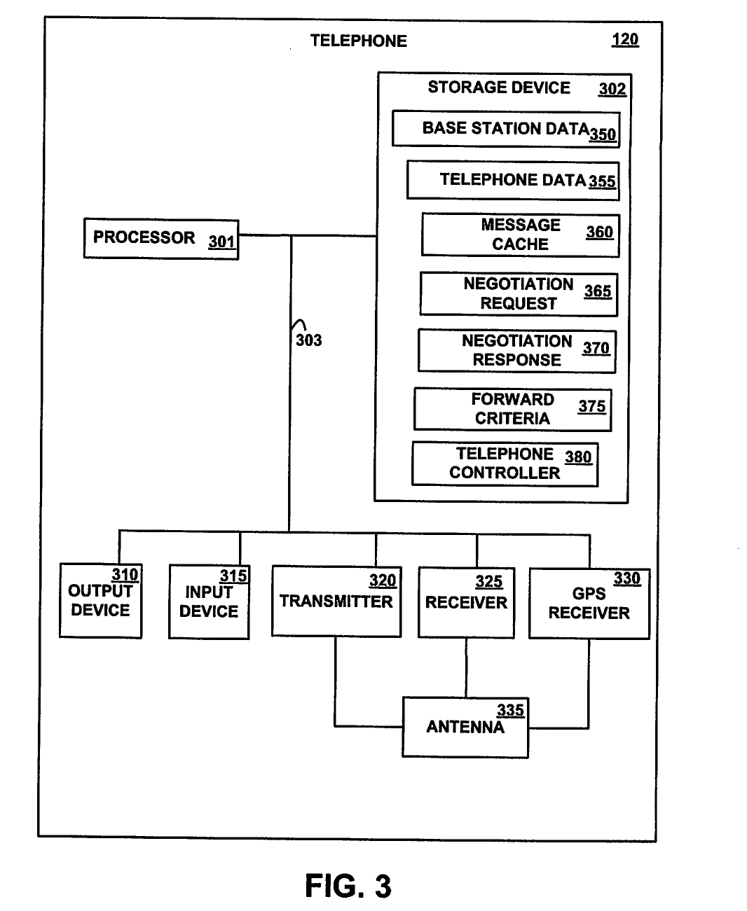

FIG. 3 depicts a block diagram of a telephone 120, according to an embodiment of the invention. The telephone 120 generically refers to the telephones 120-1, 120-2, 120-3, 120-4, and 120-5 (FIG. 2). The telephone 120 includes a processor 301, a storage device 302, an output device 310, an input device 315, a transmitter 320, a receiver 325, and a GPS receiver 330, all connected directly or indirectly via a bus 303. The transmitter 320, the receiver 325, and the GPS receiver 330 are further connected to an antenna 335, but in other embodiments some or all of the transmitter 320, the receiver 325, and the GPS receiver 330 may use a different antenna. Although the telephone 120 is depicted in FIG. 3 as being a stand-alone system, in other embodiments the telephone 120 may be embedded as part of another device, such as a modem, fax machine, automobile, appliance, navigation system, laptop or notebook computer, pager, PDA (Personal Digital Assistant), or any other appropriate device.

The processor 301 represents a central processing unit of any type of architecture, such as a CISC (Complex Instruction Set Computing), RISC (Reduced Instruction Set Computing), VLIW (Very Long Instruction Word), or a hybrid architecture, although any appropriate processor may be used. The processor 301 executes instructions and includes that portion of the telephone 120 that controls the operation of the entire telephone. The processor 301 reads and/or writes code and data to/from the storage device 302, the output device 310, the input device 315, the transmitter 320, the receiver 325, and the GPS receiver 330 via the bus 303.

The storage device 302 represents one or more mechanisms for storing data. For example, the storage device 302 may include read only memory (ROM), random access memory (RAM), magnetic disk storage media, hard disk media, floppy disk media, tape media, CD (compact disk) media, DVD (digital video disk or digital versatile disk) media, optical storage media, flash memory devices, and/or other computer-readable media. In other embodiments, any appropriate type of storage device may be used. Although only one storage device 302 is shown, multiple storage devices and multiple types of storage devices may be present. The storage device 302 stores or is encoded with base station data 350, telephone data 355, a message cache 360, a negotiation request 365, a negotiation response 370, forward criteria 375, and a telephone controller 380.

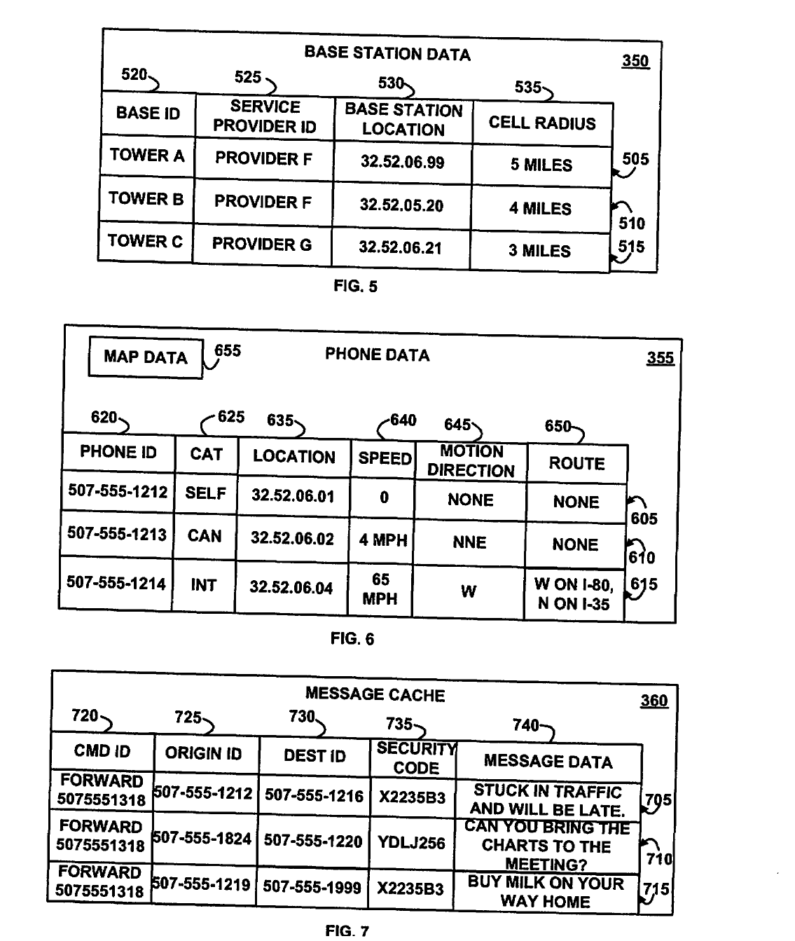

The base station data 350 describes the base stations 105 and their locations. In an embodiment, the telephone 120 receives the base station data 350 or portions of the base station data 350 as the telephone 120 moves through the cells and receives signals from the base stations 105. In other embodiments, the telephone 120 is loaded with the base station data 350 at the time of manufacture, installation, activation, or upgrade. The base station data 350 is further described below with reference to FIG. 5.

The telephone data 355 describes the telephone 120, and the location, speed, direction of motion, and/or planned route of the telephone 120. A telephone may move because it is being carried by a user or because the telephone is located within or is a part of any moving object regardless of the means of propulsion, such as an automobile, bicycle, motorcycle, boat, or airplane. The telephone controller 380 updates the telephone data 355 as the telephone moves. The telephone controller 380 updates the telephone data 355 in response to receiving signals from the GPS satellites 180 via the antenna 335 and the GPS receiver 330. The telephone data 355 is further described below with reference to FIG. 6. The message cache 360 stores saved messages and forward request messages. The message cache 360 is further described below with reference to FIG. 7.

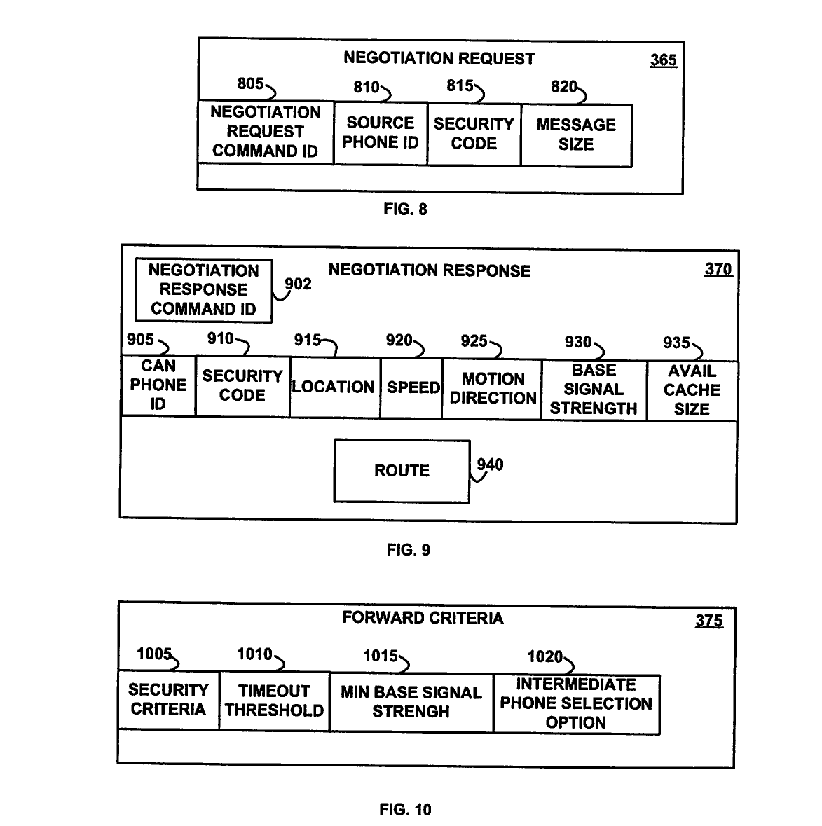

The telephone controller 380 sends the negotiation request 365 over its local wireless network in an attempt to find candidate telephones. Candidate telephones respond with negotiations responses 370. The telephone controller 380 selects intermediate telephone(s) from the candidate telephones that send the negotiation responses 370 and sends forward requests from the message cache 360 to the intermediate telephones. The negotiation request 365 is further described below with reference to FIG. 8. The negotiation response 370 is further described below with reference to FIG. 9. The forward criteria 375 contains data or rules that the telephone controller 380 uses to select intermediate telephones. The forward criteria 375 are further described below with reference to FIG. 10.

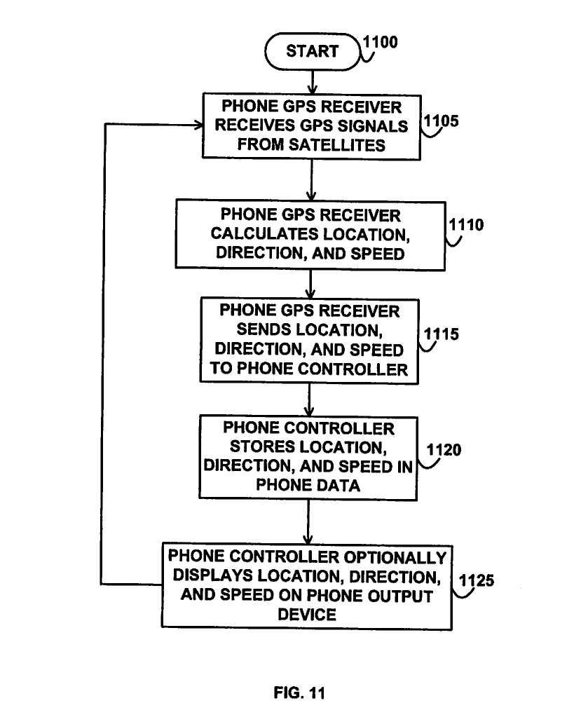

The telephone controller 380 includes instructions capable of executing on the processor 301 or statements capable of being interpreted by instructions executing on the processor 301 to carry out the functions as further described below with reference to FIGS. 11, 12, 13, 14, 15, 16, and 17. In another embodiment, the telephone controller 380 may be implemented either partially or completely in hardware via logic gates and/or other appropriate hardware techniques in lieu of or in addition to a processor-based telephone.

The output device 310 presents output to the user. The output device 310 may be a display, speaker, or any other appropriate output device or combination thereof. Although only one output device 310 is shown, in other embodiments, any number of output devices of the same type or of different types may be present.

The input device 315 may be a keyboard, mouse or other pointing device, trackball, touchpad, touchscreen, keypad, microphone, voice recognition device, or any other appropriate mechanism for the user to input audio, video, text, data, or any combination thereof to the telephone 120 and/or to manipulate the user interfaces of the telephone 120. Although only one input device 315 is shown, in another embodiment any number of input devices of the same type or of different types may be present.

The transmitter 320 receives data from the processor 301 via the bus 303 and sends signals to the antenna 335. The receiver 325 receives signals from the antenna 335 and sends data to the processor 301 via the bus 303. The antenna 335 transmits and receives wireless radio signals to and from a base station 105 if the telephone 105 is within a cell 205-1 or 205-2. The antenna 335 further transmits and receives wireless radio signals to and from other telephones via a local wireless network if within their local wireless network transmission area. The antenna 335 further receives signals from the satellites 180 and sends data to the GPS receiver 330. In an embodiment, some or all of the GPS receiver 330, the local wireless network, and the cell may used a different antenna. In an embodiment, a different transmitter and/or a different receiver may be used to send and receive signals from the local wireless network and the cell.

The GPS receiver 330 calculates the location, speed, and direction of the telephone 120 in response to signals received from the GPS satellites 180 at different times. In another embodiment, some or all of the functions of the GPS receiver 330 may be performed by the phone controller 380.

The various software components illustrated in FIG. 3 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the telephone 120 and that, when read and executed by one or more processors in the telephone 120, cause the telephone to perform the steps necessary to execute steps or elements embodying the various aspects of an embodiment of the invention.

Moreover, while embodiments of the invention have and hereinafter will be described in the context of fully functioning electronic devices, such as the telephones 120, the various embodiments of the invention are capable of being distributed as a program product in a variety of forms, and the invention applies equally regardless of the particular type of signal-bearing medium used to actually carry out the distribution. The programs defining the functions of this embodiment may be delivered to the telephones via a variety of tangible signal-bearing media, which include, but are not limited to:

(1) information permanently stored on a non-rewriteable storage medium, e.g., a read-only memory device attached to or within an electronic device, such as a CD-ROM readable by a CD-ROM drive;

(2) alterable information stored on a rewriteable storage device 302, e.g., a hard disk drive or diskette; or

(3) information conveyed to an electronic device by a communications medium, such as through a computer or a telephone network, e.g., the network 108.

Such tangible signal-bearing media, when communicatively coupled (directly or indirectly) to a processor and when carrying machine-readable instructions that direct the functions of the present invention, represent embodiments of the present invention.

Embodiments of the present invention may also be delivered as part of a service engagement with a client corporation, nonprofit organization, government entity, internal organizational structure, or the like. Aspects of these embodiments may include configuring a computer system to perform, and deploying software systems and web services that implement, some or all of the methods described herein. Aspects of these embodiments may also include analyzing the client company, creating recommendations responsive to the analysis, generating software to implement portions of the recommendations, integrating the software into existing processes and infrastructure, metering use of the methods and systems described herein, allocating expenses to users, and billing users for their use of these methods and systems.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 3 are not intended to limit the present invention. Indeed, other alternative hardware and/or software environments may be used without departing from the scope of the invention.

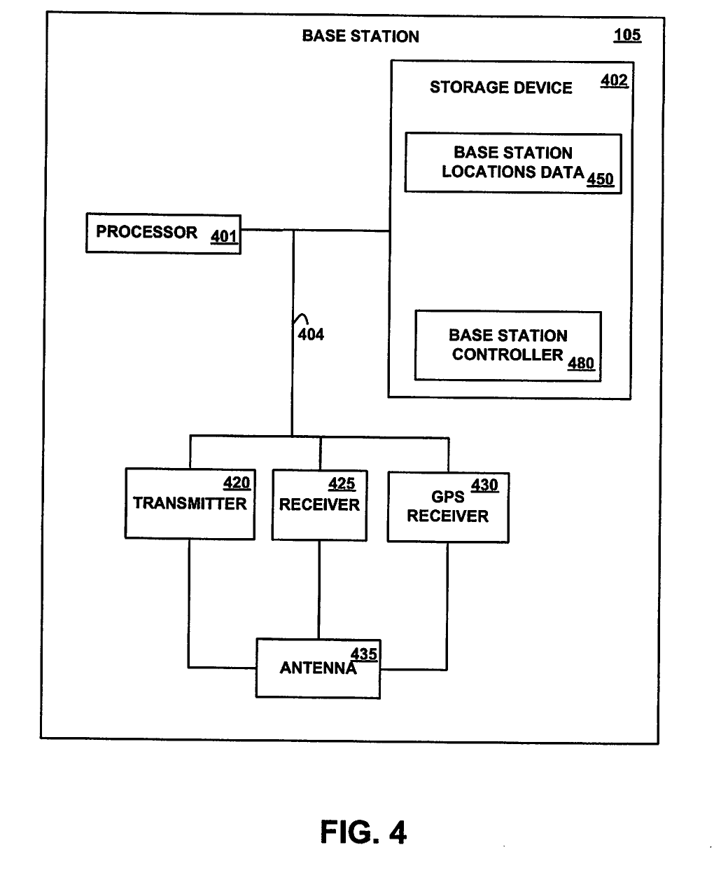

FIG. 4 depicts a block diagram of a base station 105, according to an embodiment of the invention. The base station 105 includes a processor 401, a storage device 402, a transmitter 420, a receiver 425, and a GPS receiver 430, all connected directly or indirectly via a bus 404. The transmitter 420, the receiver 425, and the GPS receiver 430 are further connected to an antenna 435, but in other embodiments some or all of the transmitter 420, the receiver 425, and the GPS receiver 430 may use a different antenna.

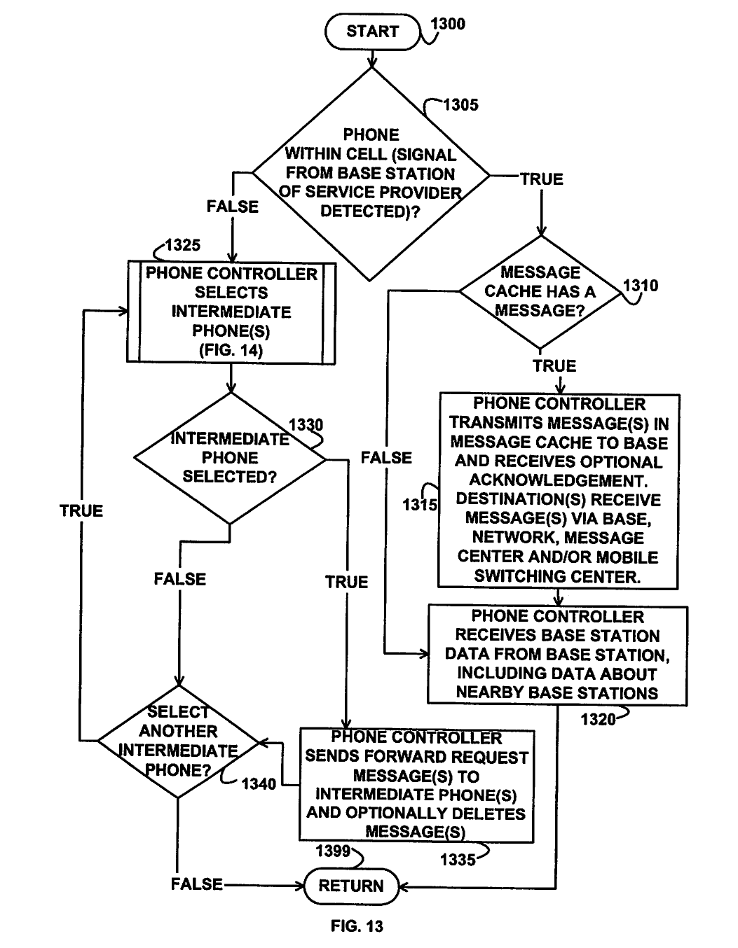

The storage device 402 includes base station locations data 450 and a base station controller 480. The base station controller 480 includes instructions capable of executing on the processor 401 or statements capable of being interpreted by instructions executing on the processor 401 to carry out the functions as further described below with reference to FIG. 13. In another embodiment, the base station controller 480 may be implemented via logic gates and other hardware in lieu of or in addition to a processor-based system. The base stations locations data 450 includes information that describes the base station 105 and its location. In other embodiments, the base station locations data 450 may also describe nearby base stations and their locations, or all base stations.

The base stations controller 480 receives messages and telephone calls from the antenna 435 via the receiver 425 and routes them to the mobile switching center 106, which routes them to the message center 102, the network 108, or to the mobile switching center associated with the base station in whose cell 205-1 or 205-2 the destination telephone 125 is located. The base station controller 480 further receives messages and telephone calls from the mobile switching center 106 and sends them to the destination telephone 125 via the transmitter 420 and the antenna 435 if the destination telephone 125 is located with the cell 205-1 or 205-2 of the base station 105. The base station controller 480 further detects, registers, and passes off the telephones 120 to other base stations 105 as they enter and leave the cell 205-1 or 205-2 of the base station. The base station controller 480 receives location information from the GPS receiver 430 that describes the location of the base station 105, updates the base station locations data 450 with the location information, and sends the base station locations data 450 to the telephones 120 when they are located with the cell of the base station. The base station controller 480 may further send the base station locations data 450 to and receive the base station locations data 450 from the mobile switching center 106. In another embodiment, some or all of the functions of the base station controller 480 may be performed by the mobile switching center 106.

FIG. 5 depicts a block diagram of the base station data 350, according to an embodiment of the invention. The base station data 350 includes example records 505, 510, and 515, each of which includes a base station identifier 520, a service provider identifier 525, a base station location 530, and a cell radius 535. The base station identifier 520 identifies the base station 105. The service provider identifier 525 identifies the telephone company that provides wireless service to its subscribers and optionally to the subscribers of other service providers via roaming. The base station location 530 specifies the physical geographic location of the base station or of the antenna of the base station. In various embodiments, the base station location 530 is specified in units of latitude and longitude, a street address, a highway and mile marker, a coordinate system, or any other appropriate units. The cell radius 530 specifies the theoretical calculated or measured radius of the signal transmission area of the cell 205-1 or 205-2 around the antenna 435 of the base station 105. In another embodiment, the cells radius 530 is optional or not used.

FIG. 6 depicts a block diagram of telephone data 355, according to an embodiment of the invention. The telephone data 355 includes example records 605, 610, and 615, each of which includes a telephone identifier field 620, a category field 625, a location field 635, a speed field 640, a direction of motion field 645, and a route field 650. The telephone identifier 620 identifies the telephone 120 that stores the telephone data 355 plus other telephones, such as candidate telephones and intermediate telephones within the transmission area of the telephone's local wireless network. In various embodiments, the telephone identifier 620 may include the telephone number, the electronic serial number (ESN), or the mobile identification number (MIN) of the telephone 120.

The category field 625 identifies the record as describing the telephone that stores the telephone data (e.g. the record 605), a candidate telephone (e.g., the record 610), or an intermediate telephone (e.g., the record 615). The location field 635 identifies the geographic location or position of the telephone 120 described by the record, and may be expressed in units of latitude and longitude, a street address, a highway and mile marker, a coordinate system, or any other units. The speed field 640 specifies the speed or rate at which the telephone 120 is currently moving. The motion direction field 645 specifies the direction or heading at which the telephone 120 is currently moving or pointing, and may be expressed as north, south, east, west, degrees, any combination thereof, or any other appropriate units.

The route field 650 is optional and specifies the current and/or planned future route, roads, streets, and directions that the telephone 120 is taking or will take. The telephone controller 380 may create the route 650 as part of a navigation system that gives the user of the telephone 120 turn-by-turn directions. The route 650 may include the intended destination location of the telephone 120. In an embodiment, the telephone data 355 also includes map data 655, which describes addresses, roads, trails, rivers, channels, elevations, landmarks, bridges, points of interest, and/or any other appropriate information.

FIG. 7 depicts a block diagram of a message cache 360, according to an embodiment of the invention. The message cache 360 includes example records 705, 710, and 715, each of which represents a message and includes a command identifier field 720, an origin telephone identifier 725, a destination telephone identifier field 730, a security code field 735, and a message data field 740. The command identifier field 720 stores a command or request that specifies the action that the telephone controller 380 should perform on the message. For example a command identifier 720 that specifies a forward request message instructs the telephone controller 380 that the telephone that contains the message cache 360 is not the intended destination of the message, but that instead the telephone controller 380 should send or forward the message to an intermediate telephone or to the base station 105. In an embodiment, the command identifier 720 specifies the telephone identifier of the intermediate telephone (or all intermediate telephones) that forward or have forwarded the message.

The origin telephone identifier 725 specifies the telephone 120 that originated the message data 740. The destination telephone identifier field 730 specifies the destination telephone 125 for which the message data 740 is intended. The security code field 735 specifies a security key, password, encryption technique, verification technique, signature, group of telephones to which the origin telephone belongs, or any combination or multiple thereof. The message data field 740 may include text, audio, video, image data, or any other appropriate data.

FIG. 8 depicts a block diagram of a negotiation request 365, according to an embodiment of the invention. The negotiation request 365 is a packet of data that a source telephone sends to candidate telephone(s) within the source telephone's local wireless network transmission area. The source telephone sends the negotiation request 365 in an attempt to identify candidate telephones, from which the source telephone selects target telephone(s) to receive forward message requests.

The negotiation request 365 includes a negotiation request command identifier field 805, a source telephone identifier field 810, a security code field 815, and a message size field 820. The negotiation request command identifier 805 identifies the packet as a negotiation request 365. The source telephone identifier 810 identifies the source telephone that sends the negotiation request 365. The security code 815 specifies a security key, password, verification technique, signature, or group of telephones to which the source telephone 810 belongs. The message size 820 specifies the size or amount of data that the source telephone desires to forward in a future forward request (e.g., the size of the records 705, 710, and/or 715) that the source telephone desires to send.

FIG. 9 depicts a block diagram of a negotiation response 370, according to an embodiment of the invention. The negotiation response 370 is a packet of data that candidate telephones send as a response to a received negotiation request 365. The negotiation response 370 includes a negotiation response command identifier field 902, a candidate telephone identifier 905, a security code field 910, a location field 915, a speed field 920, a direction of motion field 925, a base station signal strength field 930, an available cache size field 935, and a route field 940. The negotiation response command identifier 902 identifies the packet as a negotiation response 370. The candidate telephone identifier 905 identifies the candidate telephone that received the negotiation request 365 and sends the negotiation response 370. The security code 910 specifies a security key, password, verification technique, signature, or group of telephones to which the candidate telephone 905 belongs.

The location field 915 specifies the geographic location or position of the candidate telephone 905. The speed field 920 specifies the speed or rate at which the candidate telephone 905 is currently traveling. The motion direction field 925 specifies the heading or geographic direction at which the candidate telephone 905 is currently traveling. The base station signal strength field 930 specifies the strength or intensity of the signal that the candidate telephone is currently receiving from a base station 105 if the candidate telephone 905 is currently located within a cell 205-1 or 205-2. In an embodiment, signal strength is measured in terms of dBm (decibels above or below one milliwatt). In another embodiment, the signal strength may include a signal-to-noise ratio (SNR) (a comparison of the signal strength with the noise that is interfering). The available cache size field 935 specifies the amount of free or available memory that the candidate telephone 905 is willing to use to store received forward requests. The route field specifies the current and/or planned routes, roads, streets, directions, or headings that the candidate telephone 905 plans to take on its way to a destination location.

FIG. 10 depicts a block diagram of a forward criteria 375, according to an embodiment of the invention. The forward criteria 375 includes a security criteria 1005, a timeout threshold 1010, a minimum base signal strength field 1015, and an intermediate telephone selection option field 1020.

The security criteria 1005 specifies a rule, algorithm, data, threshold, or any combination or multiple thereof for evaluating whether a security code 815, 910 is valid or satisfied. The timeout threshold 1010 specifies a threshold amount of time for performing actions. The minimum base signal strength field 1015 specifies a minimum amount of signal strength that the telephone controller 380 uses to decide whether to select a candidate telephone as an intermediate telephone. The intermediate telephone selection option field 1020 specifies an option for selecting intermediate telephones from candidate telephones. In various embodiment, the intermediate telephone selection option field 1020 specifies the selection of: an intermediate telephone that has a security code that meets a security criteria, a threshold number of intermediate telephones, an intermediate telephone that has cache available to accept messages, an intermediate telephone that has an earlier estimated arrival time than the source telephone, or any combination or multiple thereof.

FIG. 11 depicts a flowchart of example processing for receiving signals from GPS satellites, according to an embodiment of the invention. Control begins at block 1100. Control then continues to block 1105 where the GPS receiver 330 receives signals from multiple satellites 180 via the antenna 335. In an embodiment, the signals contain a code that identifies the satellite 180, ephemeris data, and almanac data. The ephemeris data identifies the location of the GPS satellite 180 at any time. The almanac data contains status information and the current date and time.

Control then continues to block 1110 where the GPS receiver 330 calculates its location, direction, and speed of movement. The GPS receiver 330 measures the time delay between the time that the signal was transmitted by the satellite 180 and the time the signal was received. The GPS receiver 330 multiples this time delay by the speed of light, which gives a calculated distance from the GPS receiver 330 to that satellite 180 and locates the GPS receiver 330 on a theoretical sphere whose center is the satellite 180 and whose radius is the calculated distance. The GPS receiver 330 repeats this process with multiple satellites 180, generating multiple theoretical spheres. The GPS receiver 330 then performs a technique called triangulation to generate the intersection of four or more spheres, which yields the location of the GPS receiver 330. The GPS receiver 330 then calculates its location at multiple times and uses this information to calculate its speed, direction, and distance traveled.

Control then continues to block 1115 where the GPS receiver 330 sends the location, direction, and speed to the telephone controller 380. Control then continues to block 1120 where the telephone controller 380 stores the location 635, direction 645, and speed 640 in the telephone data 355. Control then continues to block 1125 where the telephone controller 380 optionally displays the location, direction, and speed on the output device 310. Control then returns to block 1105 where the process repeats.

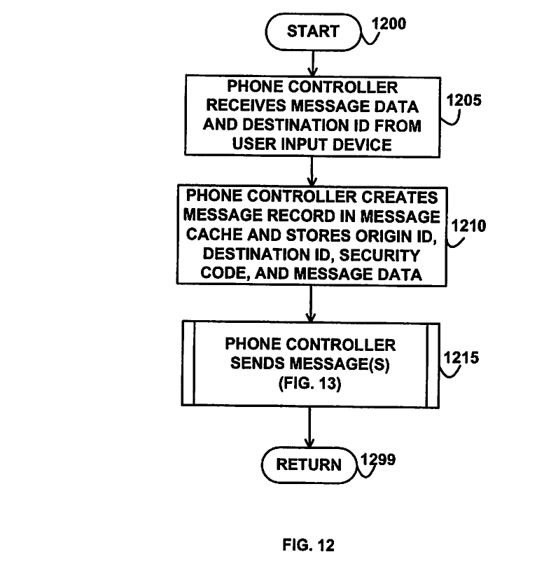

FIG. 12 depicts a flowchart of example processing for message data, according to an embodiment of the invention. Control begins at block 1200. Control then continues to block 1205 where the telephone controller 380 at the origin telephone 120-1 receives the telephone number of the destination telephone 125 from the input device 315 or determines or retrieves the telephone number from the storage device 302 and receives the message data from the input device 315. Control then continues to block 1210 where the telephone controller 380 creates a message record in the message cache 360 and stores the origin telephone identifier 725, the destination telephone identifier 730, and the message data 740. The telephone controller 380 further creates a security code 735. Control then continues to block 1215 where the telephone controller 380 sends the message(s) in the message cache 360, as further described below with reference to FIG. 13. Control then continues to block 1299 where the logic of FIG. 12 returns.

FIG. 13 depicts a flowchart of example processing for sending messages, according to an embodiment of the invention. Control begins at block 1300. Control then continues to block 1305 where the telephone controller 380 determines whether the telephone 120 is located within a cell 205-1 or 205-2. The telephone controller 380 makes the determination by detecting whether a wireless signal is received (via the antenna 335 and the receiver 325) from a base station 105. In an embodiment, the telephone controller 380 sends an identifier of the telephone 120 to the base station 105 and determines, based on data in the received wireless signal, whether the base station 105 is operated by a service provider that offers a service plan to which the telephone 120 (or the user of the telephone) subscribes. In an embodiment, the telephone controller 380 also determines whether the signal strength (the amount of energy or power) in a received signal is below a minimum amount, such as the minimum base station signal strength 1015. In an embodiment, signal strength is measured in terms of dBm (decibels above or below one milliwatt). In another embodiment, the signal strength may include a signal-to-noise ratio (SNR) (a comparison of the signal strength with the noise that is interfering).

If the determination at block 1305 is true, then the telephone 120 is within a cell 205-1 or 205-2, so control continues to block 1310 where the telephone controller 380 determines whether its message cache 360 contains a message that needs to be sent. If the determination at block 1310 is true, then the message cache 360 does contain a message that needs to be sent, so control continues to block 1315 where the telephone controller 380 transmits the message(s), including (optionally) the origin telephone identifier 725, the destination telephone identifier 730, and message data 740 to the base station 105. The base station 105 receives the message(s) and sends them to the mobile switching center 106, which routes them to the message center 102, the network 108, or to the mobile switching center in whose cell 205-1 or 205-2 the destination telephone 125 identified by the destination telephone identifier 730 is located. The telephone controller 380 deletes the forwarded messages from its message cache 360, i.e., the telephone controller 380 deletes those messages for which the telephone 120 is acting as an intermediate telephone. The telephone controller 380 further receives any messages for which the telephone 120 is a destination telephone.

In embodiment, the message center 102, the base station 105, the mobile switching center 106, or the destination telephone 125-1 or 125-2 determine whether an identical message has already been received and discard duplicate identical messages. Messages may be determined to be duplicates if they have identical origin identifiers 725, destination identifiers 730, and message data 740. Duplicate messages may occur if a source telephone sends the same message to multiple intermediate telephones, and more than one of the intermediate telephones forward the message to a base station.

In an embodiment, the message center 102, the base station 105, the mobile switching center 106, or the destination telephone 125-1 or 125-2 send an acknowledgment to the origin telephone, which indicates that the forwarded message has been received. The origin telephone receives the acknowledgment after the origin telephone enters a cell.

Control then continues to block 1320 where the base station 105 optionally sends the base station locations data 450, which the telephone controller 380 receives and stores in the base station data 350. Control then continues to block 1399 where the logic of FIG. 13 returns.

If the determination at block 1310 is false, then the message cache 360 does not contain a message, so control continues to block 1320, as previously described above.

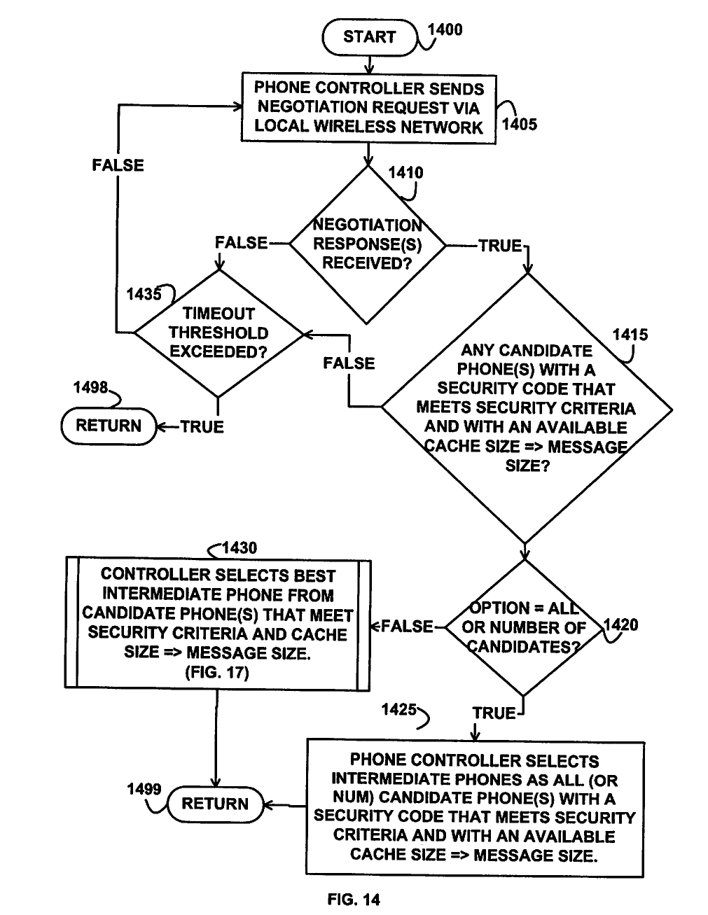

If the determination at block 1305 is false, then the telephone 120 is not located within the cell 205-1 or 205-2, so control continues to block 1325 where the telephone controller 380 selects an intermediate telephone or telephones, as further described below with reference to FIG. 14. Control then continues to block 1330 where the telephone controller 380 determines if an intermediate telephone was selected by the logic of FIG. 14. If the determination at block 1330 is true, then an intermediate telephone was selected, so control continues to block 1335 where the telephone controller 380 sends forward request message(s) (adding the identifier of the intermediate telephones to the command identifier 720) from the message cache 360 to the selected intermediate telephones. The telephone 120 of the telephone controller 380 that sends the forward requests messages is the source telephone with respect to the intermediate telephones. The telephone controller 380 deletes the sent messages from the message cache 360 if the messages are no longer needed for further forwarding.

Control then continues to block 1340 where the telephone controller 380 determines whether to select another intermediate telephone by determining whether the number of intermediate telephones already selected for the message is less than the maximum number specified by the intermediate telephone selection option 1020. If the determination at block 1340 is true, the maximum number of intermediate telephones for the current message has not yet been exceeded, so control returns to block 1325 where the telephone controller 380 selects more intermediate telephones, as previously described above. If the determination at block 1340 is false, then the message has already been forwarded to the maximum number of intermediate telephones, so control continues to block 1399 where the logic of FIG. 13 returns.

If the determination at block 1330 is false, then an intermediate telephone was not selected by the logic of FIG. 14, so control continues to block 1340, as previously described above.

FIG. 14 depicts a flowchart of example processing for selecting an intermediate telephone by a source telephone, according to an embodiment of the invention. Control begins at block 1400. Control then continues to block 1405 where the telephone controller 380 at the source telephone builds a negotiation request 365, storing the negotiation request command identifier 805, the source phone identifier, the security code 815, and the message size 820 that indicates the amount of data that the telephone controller 380 desires to forward. The telephone controller 380 sends the negotiation request 365 to the transmission area of its local wireless network.

Control then continues to block 1410 where the source telephone controller 380 determines whether it has received any negotiation response(s) 370 to the negotiation request 365 from candidate telephones. If the determination at block 1410 is true, then the source telephone controller 380 has received negotiation response(s), so control continues to block 1415 where the source telephone controller 380 determines whether any candidate telephones have responded with a negotiation response 370 that contains a security code 910 that meets the security criteria 1005 and with an available cache size 935 that is greater than or equal to the message size 820 in the negotiation request 365. By receiving a negotiation response, the telephone controller 380 detects that a candidate telephone is connected to the source telephone via a local wireless network and is within the transmission area 215 of its local wireless network.

If the determination at block 1415 is true, then at least one candidate telephone exists with a security code 910 that meets the security criteria 1005 and with enough available cache size 935 to accept forward request(s), so control continues to block 1420 where the source telephone controller 380 determines whether the intermediate telephone selection option 1020 specifies that the forward request is to be sent to all or a specified number of candidate telephones. If the determination at block 1420 is true, then the option 1020 specifies that the forward request is to be sent to all or a specified number of candidate telephones, so control continues to block 1425 where the source telephone controller 380 selects all (or the number specified) intermediate telephones from the candidate telephones that have a security code 910 that meets the security criteria 1005 and that have an available cache size 935 that is greater than or equal to the message size 820. Control then continues to block 1499 where the logic of FIG. 14 returns.

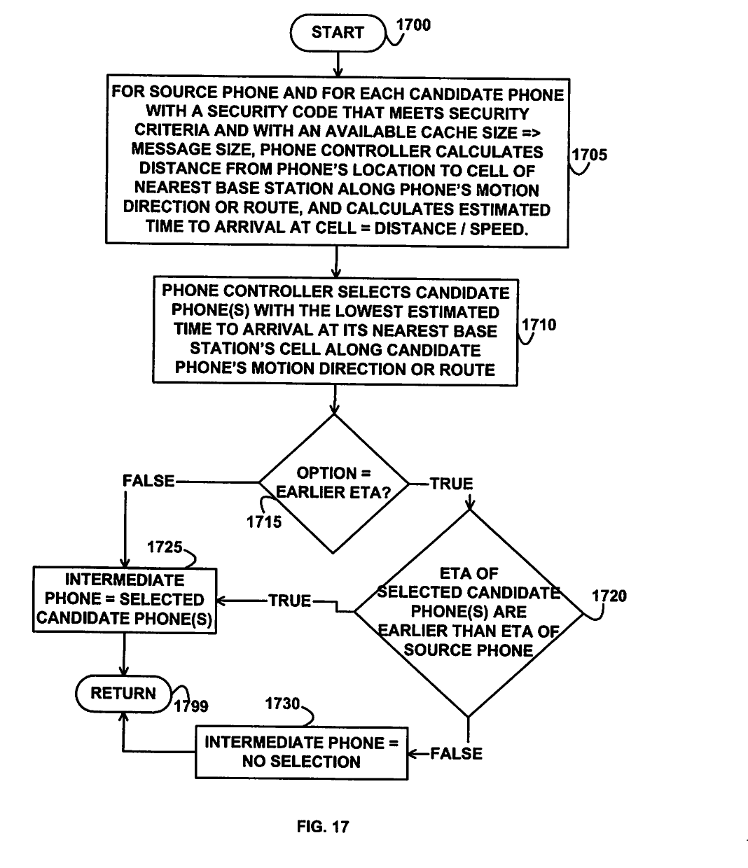

If the determination at block 1420 is false, then the intermediate telephone selection option 1020 specifies that the forward request is to be sent to the best candidate telephone, so control continues to block 1430 where the source telephone controller 380 selects the intermediate telephone to be best candidate telephone with a security code 910 that meets the security criteria 1005 and that has an available cache size 935 that is greater than or equal to the message size 820, as further described below with reference to FIG. 17. Control then continues to block 1499 where the logic of FIG. 14 returns.

If the determination at block 1415 is false, then at least one candidate telephone does not exist with a security code 910 that meets the security criteria 1005 and with enough available cache size 935 to accept the forward request(s), so control continues to block 1435 where the source telephone controller 380 determines whether the timeout threshold 1010 has been exceeded. If the determination at block 1435 is true, then the amount of time consumed by waiting for negotiation responses exceeds the timeout threshold 1010, so control continues to block 1498 where the logic of FIG. 14 returns. If the determination at block 1435 is false, then the amount of time consumed by waiting for negotiation responses does not exceed the timeout threshold 1010, so control returns to block 1405 where the telephone controller again sends the negotiation request, as previously described above.

If the determination at block 1410 is false, then the source telephone controller 380 did not receive any negotiation response(s) 370, so control continues to block 1435, as previously described above.

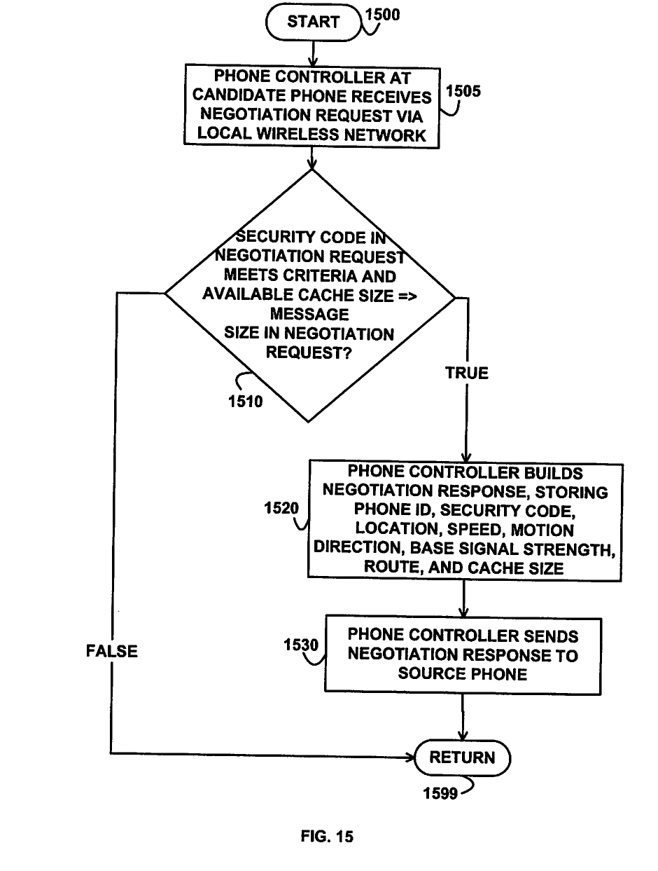

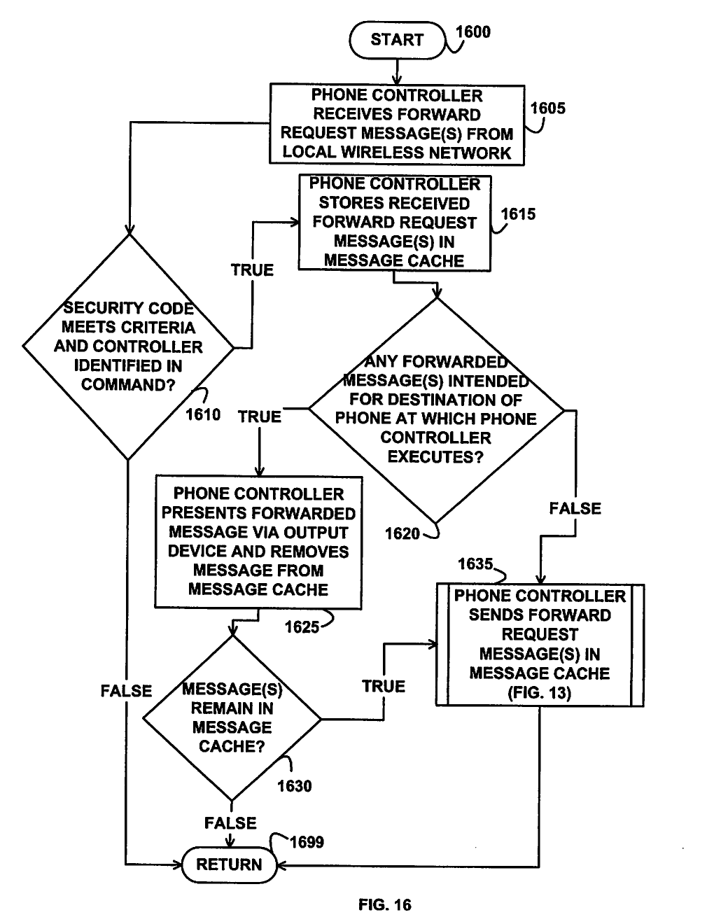

FIG. 15 depicts a flowchart of example processing for a negotiation request, according to an embodiment of the invention. Control begins at block 1500. Control then continues to block 1505 where the telephone controller 380 at a candidate telephone that is within the transmission area and connected via the local wireless network of a source telephone receives a negotiation request 365 from the source telephone via the local wireless network. Control then continues to block 1510 where the telephone controller 380 at the candidate telephone determines whether the security code 815 in the negotiation request 365 meets the security criteria 1005 of the candidate telephone and the available cache size of the candidate telephone is greater than or equal to the message size 820 in the received negotiation request 365.

If the determination at block 1510 is true, then the security code 815 in the negotiation request 365 meets the security criteria 1005 and the available cache size is greater than or equal to the message size 820 in the received negotiation request 365, so control continues to block 1520 where the candidate telephone controller 380 builds the negotiation response 370 and stores its telephone identifier 905, security code 910, location 915, speed 920, motion direction 925, base signal strength 930, available cache size 935, and route 940. The candidate telephone controller 380 further sets the negotiation response command identifier 902. In an embodiment, the location 915, speed 920, motion direction 925, and route 940 are optional or not used.

Control then continues to block 1530 where the candidate sends the negotiation response 370 to the source telephone. Control then continues to block 1599 where the logic of FIG. 15 returns.

If the determination at block 1510 is false, then the security code 815 in the negotiation request 365 does not meet the security criteria 1005 or the available cache size is not greater than or equal to the message size 820 in the negotiation request 365, so control continues to block 1599 where the logic of FIG. 15 returns.

FIG. 16 depicts a flowchart of example processing for forward requests, according to an embodiment of the invention. Control begins at block 1600. Control then continues to block 1605 where the telephone controller 380 receives a forward request from a source telephone via the local wireless network. Control then continues to block 1610 the telephone controller 380 determines whether the security code 735 in the forward request meets the security criteria 1005 and whether the telephone that receives the forward request is identified in the command 720 as an intermediate telephone.

If the determination at block 1610 is true, then the security code 735 in the forward request meets the security criteria 1005 and the telephone is identified in the command 720 as an intermediate telephone, so control continues to block 1615 where the intermediate telephone controller 380 stores the received forward request in its message cache 360. Control then continues to block 1620 where the intermediate telephone controller 380 determines whether the destination telephone identifier 730 of any messages in its message cache 360 match its own identifier, i.e., whether any of the forwarded messages are intended for the telephone that received the forward request, meaning that the intermediate telephone is the destination telephone 125.

If the determination at block 1620 is true, then the intermediate telephone is the destination telephone 125, so control continues to block 1625 where the telephone controller 380 presents the forwarded message via the output device 310 and optionally removes the message from the message cache 360. Control then continues to block 1630 where the telephone controller 380 determines whether a message remains in the message cache 360 that is intended for a destination telephone other than itself. If the determination at block 1630 is true, then a message remains in the message cache 360 that needs to be forwarded, so control continues to block 1635 where the telephone controller 380 sends the forward request, as previously described above with reference to FIG. 13. Control then continues to block 1699 where the logic of FIG. 16 returns.

If the determination at block 1630 is false, then no message remain in the message cache 360 that need to be forwarded, so control continue to block 1699 where the logic of FIG. 16 returns.

If the determination at block 1620 is false, then none of the messages in the message cache 360 are intended for the current telephone, so control continues to block 1635, as previously described above.

If the determination at block 1610 is false, then the security code 735 in the forward request does not meet the security criteria 1005 or the telephone controller 380 is not specified in the command 720, so the forward request is not intended for the current telephone 120 and the current telephone 120 is not an intermediate telephone, so control continues to block 1699 where the logic of FIG. 16 returns.

FIG. 17 depicts a flowchart of example processing at a source telephone for selecting an intermediate telephone from among candidate telephones, according to an embodiment of the invention. Control begins at block 1700. Control then continues to block 1750 where, for the source telephone and for each candidate telephone with a security code 910 that meets the security criteria 1005 and has an available cache size 935 that is greater than or equal to the message size 820 that needs to be forwarded, the source telephone controller 380 calculates the distance from each telephone to the cell 205-1 or 205-2 of the nearest base station 105 (or the edge of the cell 205-1 or 205-2 of the nearest base station 105, using the respective cell radius 535) along the telephone's direction of motion 645, 925 or planned route 650, 940. The telephone controller 380 further calculates the estimated arrival time at that cell to be the distance from the telephone to its nearest cell divided by the speed 640, 920 of the telephone. Thus, the source telephone controller 380 calculates, for itself and for all the candidate telephones, the estimated amount of time necessary to travel to or through the respective nearest cells at the current speed along the current direction or planned route.

Control then continues to block 1710 where the source telephone controller 380 selects the candidate telephone (or number of candidate telephones specified by the option 1020) with the lowest or earliest estimated arrival time at their nearest base station's cell along the candidate telephone's direction of motion or planned route. In an embodiment, the telephone controller 380 selects the candidate telephone(s) that are already located within one of the cells. In another embodiment, the source telephone controller 380 selects the candidate telephone that is located outside the cells but is moving in a direction towards at least one of the cells or moving on a planned route that travels through one of the cells.

Control then continues to block 1715 where the telephone controller 380 determines whether the option 1020 specified that the intermediate telephone selected needs to have an earlier estimated time of arrival than the source telephone. If the determination at block 1715 is true, then control continues to block 1720 where the telephone controller 380 determines whether the estimated arrival time of the selected candidate telephone(s) at the nearest cell on their direction of motion or planned route is earlier than the estimated arrival time of the source telephone at the nearest cell on its direction of motion (travel) or planned route.

If the determination at block 1720 is true, then the estimated arrival time of at least one candidate telephone at the nearest cell on its direction of travel or planned route is earlier than the estimated arrival time of arrival of the source telephone at the nearest cell on its direction of travel or planned route, so continues to block 1725 where the telephone controller 380 selects those intermediate telephone(s) with the earlier arrival times as the selected candidate telephone(s). Control then continues to block 1799 where the logic of FIG. 17 returns.

If the determination at block 1720 is false, then, then the estimated arrival time of the candidate telephone at the nearest cell on its direction of travel or planned route is not earlier than the estimated arrival time of the source telephone at the nearest cell on its direction of travel or planned route, so control continues to block 1730 where no intermediate telephone is selected. Control then continues to block 1799 where the logic of FIG. 174 returns.

If the determination at block 1715 is false, then an intermediate telephone does not need to have an earlier estimated arrival time at its nearest cell than does the source telephone, so control continues to block 1725 where the telephone controller 380 selects the intermediate telephone to be the selected candidate telephone(s). Control then continues to block 1799 where the logic of FIG. 7 returns.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. Different instances of the word “embodiment” as used within this specification do not necessarily refer to the same embodiment, but they may. The previous detailed description is, therefore, not to be taken in a limiting sense, and the scope of the present invention is defined only by the appended claims.

In the previous description, numerous specific details were set forth to provide a thorough understanding of the invention. But, the invention may be practiced without these specific details. In other instances, well-known circuits, structures, and techniques have not been shown in detail in order not to obscure the invention.

What is claimed is:

1. A method comprising:
receiving, at a source telephone, message data and an identifier of a destination telephone;
detecting that the source telephone is located outside a plurality of cells;
selecting an intermediate telephone; and
sending a forward request to the intermediate telephone, wherein the forward request comprises the message data and the identifier of the destination telephone.

2. The method of claim 1, wherein the selecting further comprises:
determining that the intermediate telephone is located within one of the cells.

3. The method of claim 1, wherein the selecting further comprises:
determining that the intermediate telephone is located outside the cells and is moving toward one of the cells.

4. The method of claim 1, wherein the selecting further comprises:
calculating, for a plurality of candidate telephones, a plurality of respective estimated arrival times at the cells; and
selecting the intermediate telephone from the candidate telephones with the shortest estimated arrival time.

5. The method of claim 4, wherein the selecting further comprises:
calculating an estimated arrival time of the source telephone at one of the cells; and
determining that the estimated arrival time of the intermediate telephone is earlier than the estimated arrival time of the source telephone.

6. The method of claim 1, wherein the selecting further comprises:
detecting that the intermediate telephone is connected to the source telephone via a local wireless network; and
determining that the intermediate telephone meets a security criteria.

7. The method of claim 1, wherein the selecting further comprises:
determining that the intermediate telephone is located outside the cells and is moving on a planned route that travels through one of the cells.

8. The method of claim 1, wherein the receiving further comprises:
receiving the message data and the identifier from a user interface of the source telephone.

9. The method of claim 1, wherein the receiving further comprises:
receiving the message data and the identifier from an origin telephone via a local wireless network.

10. A signal-bearing medium comprising:
receiving, at a source telephone, message data and an identifier of a destination telephone;
detecting that the source telephone is located outside a plurality of cells;
selecting an intermediate telephone; and
sending a forward request to the intermediate telephone, wherein the forward request comprises the message data and the identifier of the destination telephone, and wherein the forward request instructs the intermediate telephone to forward the message data.

11. The signal-bearing medium of claim 10, wherein the selecting further comprises:
determining that the intermediate telephone is located within one of the cells.

12. The signal-bearing medium of claim 10, wherein the selecting further comprises:
determining that the intermediate telephone is located outside the cells and is moving on a planned route that travels through one of the cells.

13. The signal-bearing medium of claim 10, wherein the selecting further comprises:
calculating, for a plurality of candidate telephones, a plurality of respective estimated arrival times at the cells; and
selecting the intermediate telephone from the candidate telephones with the shortest estimated arrival time.

14. The signal-bearing medium of claim 10, wherein the selecting further comprises:
detecting that the intermediate telephone is connected to the source telephone via a local wireless network; and
determining that the intermediate telephone meets a security criteria.

15. The signal-bearing medium of claim 10, wherein the receiving further comprises:
receiving the message data and the identifier from an origin telephone via a local wireless network.

16. The signal-bearing medium of claim 10, wherein the selecting further comprises selecting a plurality of the intermediate telephones, and wherein the sending further comprises sending the forward request to the plurality of intermediate telephones.

17. A source telephone comprising:
a processor; and
a storage device communicatively coupled to the processor, wherein the storage device is encoded with instructions, and wherein the instructions when executed on the processor comprise:
receiving, message data and an identifier of a destination telephone,
detecting that the source telephone is located outside a plurality of cells,
selecting an intermediate telephone that meets a security criteria, wherein the intermediate telephone is connected to the source telephone via a local wireless network, and
sending a forward request to the intermediate telephone, wherein the forward request comprises the message data and the identifier of the destination telephone, and wherein the forward request instructs the intermediate telephone to forward the message data.

18. The source telephone of claim 16, wherein the selecting further comprises:
determining that the intermediate telephone is located outside the cells and is moving on a planned route that travels through one of the cells.

19. The source telephone of claim 16, wherein the selecting further comprises:
calculating, for a plurality of candidate telephones, a plurality of respective estimated arrival times at the cells, wherein the candidate telephones are connected to the source telephone via the local wireless network; and
selecting the intermediate telephone from the candidate telephones with the shortest estimated arrival time.

20. The source telephone of claim 16, wherein the receiving the message data and the identifier of a destination telephone further comprises:
receiving the forward request from an origin telephone.

21. The source telephone of claim 16, wherein the selecting further comprises selecting a plurality of the intermediate telephones, and wherein the sending further comprises sending the forward request to the plurality of intermediate telephones.
